(19) United States
(12) Patent Application Publication
(10) Pub. No.: US 2005/0224607 A1
(43) Pub. Date: Oct. 13, 2005

(54) Flow regulators with flexible diaphragms

(76) Inventors: Eldad Dinur, Kibbutz Naan (IL); Moshe Gorny, Kibbutz Naan (IL)

Correspondence Address: Mark M Friedman;Bill Polkinghorn, Discovery Dispatch, 9003 Florin Way, Upper Marlboro, MD, 20772, US

(21) Appl. No.: 10/204,627

(22) PCT Filed: Feb. 21, 2001
(86) PCT No.: PCT/IL01/00162

§ 371 Date: Aug. 22, 2002

(30) Foreign Application Priority Data
Feb. 23, 2000 (IL) 134695

(51) Int. Cl. B05B 15/00

(52) U.S. Cl. 239/542

(57) ABSTRACT

A flow regulator (10) for regulating a rate of flow of a liquid from an inlet flow path to an outlet flow path. The flow regulator includes a housing (14) with one wall or more which defines, at least in part, a regulation chamber (16) with all annular surface (18) and an outlet aperture (20) in fluid communication with the outlet flow path. The flow regulator also includes a flexible diaphragm (22) deployed at least partially within the regulation chamber (16), the diaphragm (22) having a first surface (24) part of which faces towards the annular surface (18) and a second surface (26) part of which face towards the outlet aperture (20), the diaphragm (22) assuming an initial unflexed position in which part of the first surface (24) lies adjacent to the annular surface (18), the diaphragm (22) is displaceable under pressure applied from the inlet flow path to a flexed position in which the first surface (24) is at least partially removed from the annular surface (18) and a contact portion of the second surface (26) obstructs the outlet aperture (20).

### FIELD AND BACKGROUND OF THE INVENTION

The present invention relates to irrigation devices and, in particular, it concerns flow regulators employing flexible diaphragms.

It is known to employ a flexible diaphragm to provide pressure-sensitive flow control in irrigation devices. A number of such devices are described in U.S. Pat. No. 5,820,028 to the present applicant which is hereby incorporated in its entirety.

By way of example, FIGS. 1-3 show three devices, corresponding to FIGS. 6A, 4A and 3A, respectively, from the aforementioned patent. Specifically, FIG. 1 shows a drip-irrigation emitter mounted on the inner surface of a drip-irrigation tube, FIG. 2 shows a self-contained emitter unit, and FIG. 3 shows a pulsator device. In each case, water flow is regulated by movement of a dome-shaped flexible diaphragm, part of which becomes inverted by application of a supply pressure to vary an outlet geometry defined by an outlet aperture and an inner surface of the diaphragm dome. Additional regulating effects, as well as sealing against both reverse flow and forward flow below a certain threshold pressure, are preferably provided by contact between external surfaces of the diaphragm and walls of an adjacent housing. Detailed description of the structure and operation of the three devices, including references to the numerals shown, may be found in the above-incorporated patent.

Flow regulating devices based on these diaphragm structures have been found to be highly effective in a wide range of applications. In most cases, the diaphragm tends to oscillate rapidly during operation. In addition to offering highly effective pressure-responsive flow regulation, the vibrations generated by this oscillatory motion also tend to break-up accumulations of dirt, thereby avoiding blockage of the devices.

Notwithstanding these advantages, the structures of diaphragm-based flow regulating devices proposed to-date suffer from a number of limitations. Most notably, the oscillation of the diaphragm causes repeated impact of the central portion of the diaphragm against the surfaces surrounding the outlet aperture, thereby reducing the lifetime of the device.

A further shortcoming is the sensitivity of the structures to misalignment and variations in material properties. Any non-uniformity in the elastic properties of the diaphragm, or misalignment of the diaphragm during assembly, may lead to improper seating of the diaphragm surface against the outlet aperture, thereby impairing the regulating effect.

A still further shortcoming is the speed of response of the devices to application of water pressure. Since the thickness of the diaphragm must be sufficient to provide resilient regulating properties when exposed to its normal supply pressure, a minimum thickness of the diaphragm must be sufficient to offer relatively high resistance to deformation. This results in a slow response time of the diaphragm to the initial application of supply pressure to reach its operative inverted state. During this response time, significant quantities of water may be released.

Finally, as with almost all drip-irrigation emitters which are mounted on the inner surface of a drip-irrigation tube, the device of FIG. 1 generally requires an outlet chamber (designated 426) between the outlet aperture of the regulating structure and the tube surface. This outlet chamber is required to provide sufficient tolerance for the relatively low precision hole punching process for forming outlet holes through the irrigation tube. This chamber adds significant height (typically about 1.5 mm) to the emitter structure, thereby aggravating the obstruction to flow presented by the emitter within the tube.

Reference is made, parenthetically, to German Patent No. 29 02 007. This teaches a technique for simplifying the hole punching process by inserting a cylindrical drip-irrigation insert with radial projections into an irrigation tube during extrusion. As the tube shrinks onto the insert, the radial projections cause localized bulges in the tube surface adjacent to the ends of the water supply channel. These bulges are then shaved off to form water discharge openings.

The aforementioned German patent somewhat simplifies the process of locating the outlet chamber of the insert by generating a very localized bulge at the site to be cut. The technique described is limited, however, to cylindrical inserts. Furthermore, the cylindrical inserts proposed present the same obstruction to the water flow through the tube as would be presented by conventional cylindrical inserts.

There is therefore a need for diaphragm-based flow regulating devices which would offer an increased lifetime, which would have a rapid response to applied pressure, and which would be insensitive to slight misalignment or non-uniformity of the diaphragm. It would also be highly advantageous to provide a drip-irrigation emitter for mounting within a drip irrigation tube which would present a reduced obstruction to flow through the tube.

### SUMMARY OF THE INVENTION

The present invention is a flow regulator employing a flexible diaphragm with a thickened contact portion.

According to the teachings of the present invention there is provided, a flow regulator for regulating a rate of flow of a liquid from an inlet flow path to an outlet flow path, the flow regulator comprising: (a) a housing including at least one wall which defines, at least in part, a regulation chamber having a substantially annular surface and an outlet aperture in fluid communication with the outlet flow path; and (b) a flexible diaphragm deployed at least partially within the regulation chamber, the diaphragm having a first surface part of which faces towards the substantially annular surface and a second surface part of which faces towards the outlet aperture, the diaphragm assuming an initial unflexed position in which part of the first surface lies substantially adjacent to the substantially annular surface, the diaphragm being displaceable under pressure applied from the inlet flow path to a flexed position in which the first surface is at least partially removed from the substantially annular surface and a contact portion of the second surface substantially obstructs the outlet aperture, wherein the diaphragm has at least one region having a minimum thickness defined as the distance between the first surface and the second surface, and a contact thickness defined as a distance from the contact portion to a part of the first surface, the contact thickness being at least about twice the minimum thickness.

According to a further feature of the present invention, the contact thickness is at least about three times the minimum thickness.

According to a further feature of the present invention, the diaphragm is substantially rotationally symmetric about an axis of symmetry passing through the contact portion, the contact thickness being measured parallel to the axis of symmetry.

According to a further feature of the present invention, the first surface is substantially dome-shaped when the diaphragm assumes the unflexed state.

According to a further feature of the present invention, the contact portion has a generally convexly curved shape in both the flexed and the unflexed positions of the diaphragm.

According to a further feature of the present invention, the second surface approximates to part of a spherical surface over the contact portion.

According to a further feature of the present invention, the outlet aperture has an internal diameter, the contact portion of the second surface approximating to part of a spherical surface having a radius of curvature not less than the internal diameter.

According to a further feature of the present invention, the at least one region having a minimum thickness includes an annular region circumscribing the contact portion in a substantially symmetrical configuration

According to a further feature of the present invention, the first surface has a maximum height when the diaphragm assumes the unflexed state, the housing extending upwards around the diaphragm to no more than about two-thirds of the maximum height.

According to a further feature of the present invention, the part of the first surface lies substantially in sealing abutment with the substantially annular surface when the diaphragm assumes the initial unflexed position.

According to a further feature of the present invention, the part of the first surface and the substantially annular surface are configured to allow passage of water therebetween when the diaphragm assumes the initial unflexed position.

There is also provided according to the teachings of the present invention, a drip irrigation system comprising: (a) a drip irrigation tube having an internal surface; and (b) a plurality of the aforementioned flow regulators, deployed on the internal surface, wherein each of the flow regulators further includes at least one outlet-defining projection extending substantially through the drip irrigation tube, the at least one outlet-defining projection being configured to define, at least in part, an outlet flow path in direct fluid communication with the outlet aperture and traversing the drip irrigation tube.

There is also provided according to the teachings of the present invention, a flow regulator for regulating a rate of flow of a liquid from an inlet flow path to an outlet flow path, the flow regulator comprising: (a) a housing including at least one wall which defines, at least in part, a regulation chamber having a substantially annular surface and an outlet aperture in fluid communication with the outlet flow path; and (b) a flexible diaphragm deployed at least partially within the regulation chamber, the diaphragm having a first surface part of which faces towards the substantially annular surface and a second surface part of which faces towards the outlet aperture, the diaphragm assuming an initial unflexed position in which part of the first surface lies substantially adjacent to the substantially annular surface, the diaphragm being displaceable under pressure applied from the inlet flow path to a flexed position in which the first surface is at least partially removed from the substantially annular surface and a contact portion of the second surface substantially obstructs the outlet aperture, wherein the first surface has a maximum height when the diaphragm assumes the unflexed slate, the housing extending upwards around the diaphragm to no more than about two-thirds of the maximum height.

There is also provided according to the teachings of the present invention, a drip irrigation system comprising: (a) a drip irrigation tube formed by a tubular wall and having an internal surface; and (b) a plurality of drip emitters deployed on the internal surface, each of the drip emitters extending around less than the entire periphery of the internal surface, each of the drip emitters having at least one outlet-defining projection which extends substantially through the tubular wall to define an outlet flow path.

According to a further feature of the present invention, the at least one outlet-defining projection is implemented as an outlet pipe, the outlet flow path passing through the outlet pipe.

According to a further feature of the present invention, each of the drip emitters includes: (a) a housing including at least one wall which defines, at least in part, a regulation chamber having a substantially annular surface and an outlet aperture, the outlet aperture being in direct fluid communication with the outlet flow path; and (b) a flexible diaphragm deployed at least partially within the regulation chamber, the diaphragm having a first surface part of which faces towards the substantially annular surface and a second surface part of which faces towards the outlet aperture, the diaphragm assuming an initial unflexed position in which part of the first surface lies substantially adjacent to the substantially annular surface, the diaphragm being displaceable under pressure supplied within the drip irrigation tube to a flexed position in which the first surface is at least partially removed from the substantially annular surface and a contact portion of the second surface substantially obstructs the outlet aperture.

According to a further feature of the present invention, the first surface has a maximum height when the diaphragm assumes the unflexed state, the housing extending upwards around the diaphragm to no more than about two-thirds of the maximum height.

### BRIEF DESCRIPTION OF THE DRAWINGS

The invention is herein described, by way of example only, with reference to the accompanying drawings, wherein:

FIGS. 1-3 are illustration of prior art irrigation devices corresponding to FIGS. 6A, 4A and 3A, respectively, from U.S. Pat. No. 5,820,028;

FIG. 4 is a cross-sectional view taken through a first flow regulator constructed and operative according to the teachings of the present invention, showing a flexible diaphragm in an unflexed state;

FIG. 5 is a view similar to FIG. 4 showing the flexible diaphragm in a flexed state;

FIG. 6 is an isometric view of a lower part of a housing from the flow regulator of FIG. 4;

FIGS. 7A and 7B are views similar to FIGS. 4 and 5, respectively, showing a variant of the flow regulator of FIG. 4:

FIG. 8 is a cross-sectional view showing the flow regulator of FIG. 4 deployed in a drip irrigation tube;

FIG. 9A is a schematic representation of a first device including a roller for use in production of a drip irrigation tube fitted with flow regulators of the type shown in FIG. 4;

FIG. 9B is a schematic cross-sectional view taken through the roller of FIG. 9A;

FIG. 10A is a schematic representation of a second device including a pair of displaceable wheels for use in production of a drip irrigation tube fitted with flow regulators of the type shown in FIG. 4;

FIG. 10B is a schematic plan view illustrating the pattern of overlap between the wheels of the device of FIG. 10A and the flow regulator;

FIG. 11 is a cross-sectional view taken through a second flow regulator, constructed and operative according to the teachings of the present invention; and

FIG. 12 is a cross-sectional view taken through a third flow regulator, constructed and operative according to the teachings of the present invention.

### DESCRIPTION OF THE PREFERRED EMBODIMENTS

The present invention is a flow regulator employing a flexible diaphragm with a thickened contact portion.

The principles and operation of flow regulators according to the present invention may be better understood with reference to the drawings and the accompanying description.

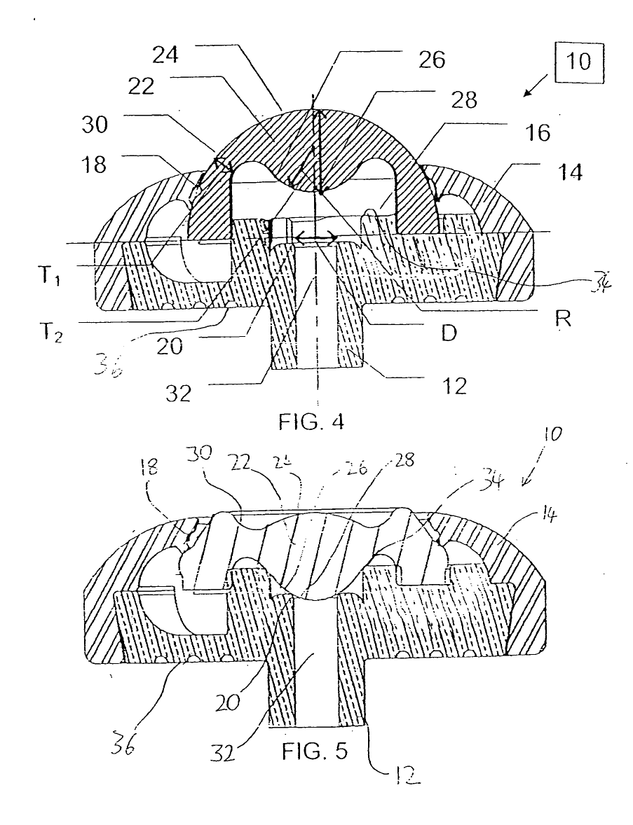

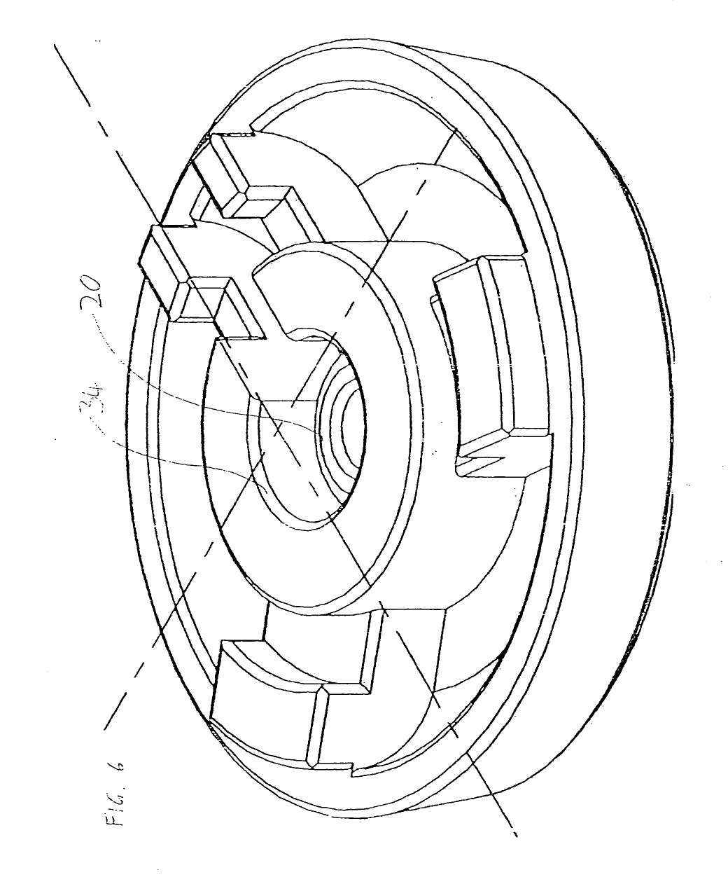

Referring now to the drawings, FIGS. 4 and 5 show a first embodiment of a flow regulator, generally designated 10, constructed and operative according to the teachings of the present invention, for regulating a rate of flow of a liquid from an inlet flow path to an outlet flow path. In this embodiment, regulator 10 is a drip emitter for mounting internally within a drip irrigation tube (not shown) such that the “inlet flow path” encompasses the entire upper surface of the regulator as shown, and the “outlet flow path” opens directly to the outside of the tube through a release conduit 12.

In general terms, regulator 10 has a housing 14 including at least one wall which defines, at least in part, a regulation chamber 16 having an annular sealing surface 18 and an outlet aperture 20 in fluid communication with the outlet flow path. A flexible diaphragm 22, deployed at least partially within regulation chamber 16, has a first surface 24 part of which faces towards annular sealing surface 18 and a second surface 26 part of which faces towards outlet aperture 20. Diaphragm 22 assumes an initial unflexed position (FIG. 4) in which part of first surface 24 lies substantially in sealing abutment with sealing surface 18. Diaphragm 22 is also displaceable under pressure applied from the inlet flow path to a flexed position (FIG. 5) in which first surface 24 is at least partially removed from sealing surface 18 and a contact portion 28 of second surface 24 substantially obstructs outlet aperture 20.

Diaphragm 22 has at least one region 30 which has a “minimum thickness” T₁ between surfaces 24 and 26. A “contact thickness” T₂ between surfaces 24 and 26 measured at contact portion 28 is at least about twice, and preferably at least about three times, the value of minimum thickness T₁.

It will be immediately apparent that the localized thickening of diaphragm 22 in the region of contact portion 28 provides the diaphragm with greatly enhanced durability without compromising the required flexibility of the diaphragm which is ensured by the thinner portions. Furthermore, the configuration of preferred implementations of the present invention also provides greater reliability of function. These and other features will be described in detail below.

Turning now to the features of flow regulator 10 in more detail diaphragm 22 is preferably substantially rotationally symmetric about an axis of symmetry 32 passing through contact portion 28. In this case, the contact thickness is preferably taken to be the distance between surfaces 24 and 26 measured parallel to axis 32.

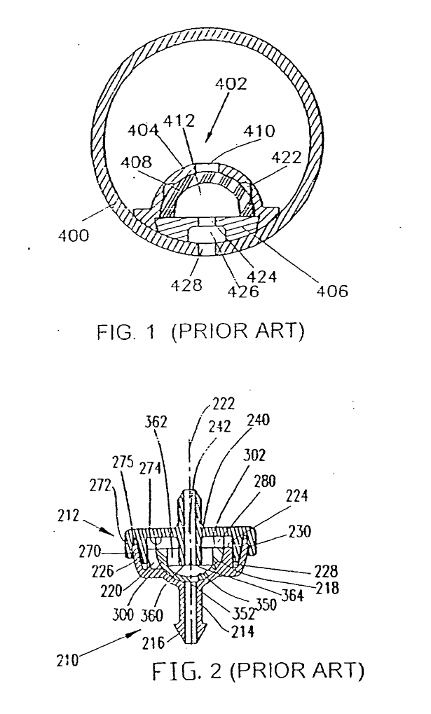

In the unflexed state of FIG. 4, diaphragm 22 preferably has an external form, as defined by first surface 24, which is substantially dome-shaped. Thus, the external shape of diaphragm 22 is generally similar to that provided by the prior art device of FIG. 1. The internal form, on the other hand, differs distinctly in order to provide the recited variations of thickness.

In preferred implementations, contact portion 28 has a generally convexly curved shape, both in the flexed and the unflexed positions of diaphragm 22, preferably approximating to part of a spherical surface. In many cases, it is preferred that the effective radius of curvature R in the region of contact portion 28 is not less than an internal diameter D of outlet aperture 20. This relatively low curvature helps to ensure that contact portion 28 seats itself properly against the aperture even if the diaphragm deviates slightly from central alignment. Parenthetically, in the context of seating of diaphragm 22 against outlet aperture 20, it should be noted that outlet aperture 20 may optionally be provided with one or more slot (not shown) configured to prevent complete sealing of the outlet by diaphragm 22. This is helpful in applications in which the percussive effects of the oscillating diaphragm are disadvantageous. Such a slot may also be useful to broaden the range of pressures over which regulation is effective.

In addition to rendering contact portion 28 less sensitive to misalignment than the prior art diaphragm structures, preferred implementations of the present invention also actually help to reduce or eliminate such misalignments. Specifically, misalignment of conventional diaphragms relative to their outlet apertures often results from non-uniformity of the diaphragm material, which leads to asymmetric deformation. This asymmetry is reduced or eliminated in preferred implementations of the present invention by localizing most of the deformation into a predefined symmetrical region of the diaphragm.

Thus, in preferred embodiments, minimum thickness region 30 is deployed as an annular region circumscribing contact portion 28 in a substantially symmetrical configuration.

In certain particularly preferred implementations of the present invention, such as is illustrated in FIGS. 4-6, an additional stop 34 is deployed within regulation chamber 16 as part of a base portion of housing 14 (see particularly FIG. 6). As seen in FIG. 5, stop 34 is configured so that a peripheral part of thickened portion of diaphragm 22 comes into contact with stop 34 before contact portion 28 reaches outlet aperture 20. Pressure responsive regulation then occurs through slight deformation of the thickened portion of the diaphragm.

It will be apparent that the provision of stop 34 offers considerable freedom of design parameters and relative proportions which cannot be achieved in the prior art structures. Specifically, since the pressure responsive regulation occurs primarily through local deformation of the part of diaphragm between stop 34 and outlet aperture 20, the minimum thickness region 30 of the diaphragm can be made considerably thinner than in the prior art. This provides a much shorter response time for the diaphragm to invert to its operative state, thereby avoiding the shortcomings of water Wastage described above in the context of the prior art.

Further variations in thickness or mechanical properties of different parts of diaphragm 22 may also be used to advantage. For example, in the preferred form of annular surface 13 shown here, the upper part of surface 18 is a generally flat abutment surface awhile the lower extreme of surface 13 provides a projecting lip operative to provide an additional regulation effect against the adjacent part of first surface 24. To ensure sufficient proximity of surface 24 to this lip to provide effective regulation, the annular minimum thickness region 30 is preferable located slightly above annular surface 18, or at least above the lower lip thereof, while the peripherally outermost region of the diaphragm is made somewhat thicker.

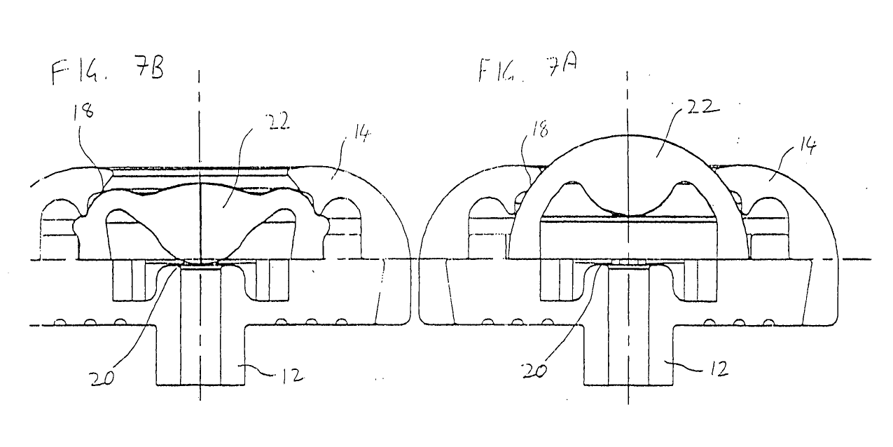

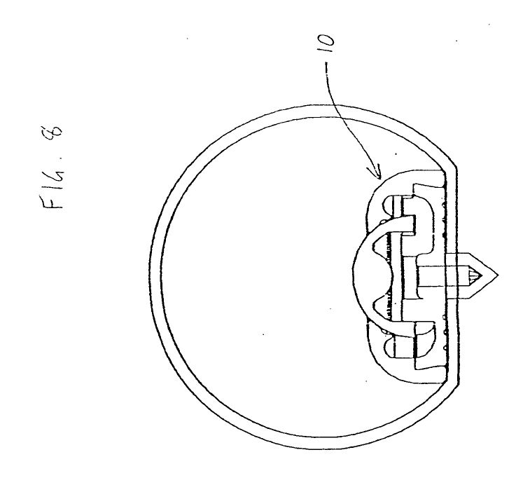

Parenthetically, while the provision of stop 34 is believed to be advantageous in many applications, it should be noted that implementations for certain applications do not employ such a structure. By way of illustration, FIGS. 7A and 7B show a variant implementation of the drip irrigation emitter of the present invention without the additional stop feature. In other respects, the implementation of FIGS. 7A and 7B is fully analogous to that of FIGS. 4-6 described herein.

As mentioned earlier, in many preferred implementations of the present invention, the contact between first surface 24 and annular surface 18 in the initial unflexed state of diaphragm 22 defines an initial seal which closes the device to flow at supply pressures less than a predefined value. The predefined cut-off value may be set by varying the pre-loading of the diaphragm against surface 18. This pre-loading is itself a function of the design and dimensions of the various components which generate a required degree of initial compression of the diaphragm in the assembled device.

Parenthetically it should be noted that the present invention is not limited to implementations with the aforementioned initial seal. In fact, in applications in which it is required that the irrigation system be emptied of water when not in use, it is generally preferred to provide emitter devices with an open low-pressure state. This may conveniently be achieved by forming a channel across or otherwise modifying annular surface 18, or by designing the various components to leave a small gap between first surface 24 and annular surface 13 in the unflexed state.

With reference now to FIG. 8, it should be noted that various features of the emitter structure shown here lend it a particularly low profile such that it poses a greatly reduced obstruction to flow through a drip irrigation tube within which it is mounted. Firstly, it will be noted that, in contrast to the hemispherical shape of the top of the housing in FIG. 1, housing 14 of preferred implementations seals against a lower portion of diaphragm 22, preferably at no more than about two-thirds of its unflexed height. As a result, when the diaphragm assumes its inverted operative state as in FIG. 5, the total height of the obstruction to the water flow along the irrigation tube is reduced markedly.

An additional preferred feature which enables a reduction of the height of the emitter is the omission of an outlet chamber. Instead, certain preferred implementations of an emitter according to the present invention provide release conduit 12 defined at least in part by one or more outlet-defining projection which projects from the plane of the lower surface 36 of housing 14. When the emitter is pressed against the inside wall of the tube during extrusion, this outlet-defining projection presses through the tube wall to form a localized bulge. To facilitate penetration through the tube wall, the outlet-defining projection preferably initially terminates in a sharp point as shown in FIG. 8 (omitted to avoid confusion in FIGS. 4-7). The bulge formed by projection of the outlet-defining projection through the tube wall is then shaved off in a manner similar to that proposed by the aforementioned German patent to form an open outlet. Unlike the German patent, however, the structure provided by the present invention preferably achieves a significant reduction in the height of the emitter by providing a direct outlet from regulation chamber 16 without use of a separate outlet chamber.

Parenthetically, it should be noted that this aspect of the present invention may also be used to advantage with a wide range of otherwise conventional, non-cylindrical drip irrigation emitters which encompass less than the entirety, and preferably less than 180°, of the internal surface of the drip irrigation tube. In each case, the height normally added by the presence of an outlet chamber can be avoided by use of an outlet-defining projection.

In the particularly preferred implementation shown here, the outlet-defining projection is formed as an outlet pipe. It should be appreciated, however, that other forms of outlet-defining projection may also be effective to define an effective outlet after shaving-off of the resulting bulge. Other examples of suitable outlet-defining projections include, but are not limited to, single projections with a U-shaped or C-shaped cross-section, and two or more spaced apart projections defining a channel therebetween. Any open sides of the outlet-defining projection(s) are sealed during production by the surrounding material of the irrigation tube wall.

The outlet flow path is described as preferably being in direct fluid communication with outlet aperture 20 and traversing the wall of the drip irrigation tube. In this context, the term “direct fluid communication” is used to refer to a flow path which passes neither through enlarged chambers nor through flow restrictions. In this context, an “enlarged chamber” is defined by an increase in cross-sectional area of the flow path of at least an order of magnitude. In a most preferred implementation, the outlet flow path has an approximately constant cross-sectional area and approximates to a straight outlet pipe extending from outlet aperture 20 and passing through the wall of the drip irrigation tube.

It will be noted that the attachment of the emitter structure described to the inside of a drip irrigation tube requires special arrangements during the production process. Unlike the cylindrical emitter of the aforementioned German patent which readily positions itself within the cylindrical shrinking tube, non-cylindrical emitters, i.e., drip emitters which extend around less than the entire periphery, and preferably less than half the periphery, of the internal surface of the tube, require controlled application of contact pressure with the soft tube to ensure proper adherence. Conventional production techniques for non-cylindrical emitters employ arrangements of rollers or the like which press the wall of the tube into contact with the insert which is supported by a track extending within the tube. An example of such techniques may be found in U.S. Pat. No. 5,271,786 to Gorney et al. In the case of the preferred structures of the present invention, these arrangements must be modified to accommodate the projection formed by the outlet-defining projection while still ensuring effective contact between the tube wall and lower surface 36 to ensure sealing attachment. Two examples of suitable devices for achieving this result will now be described briefly.

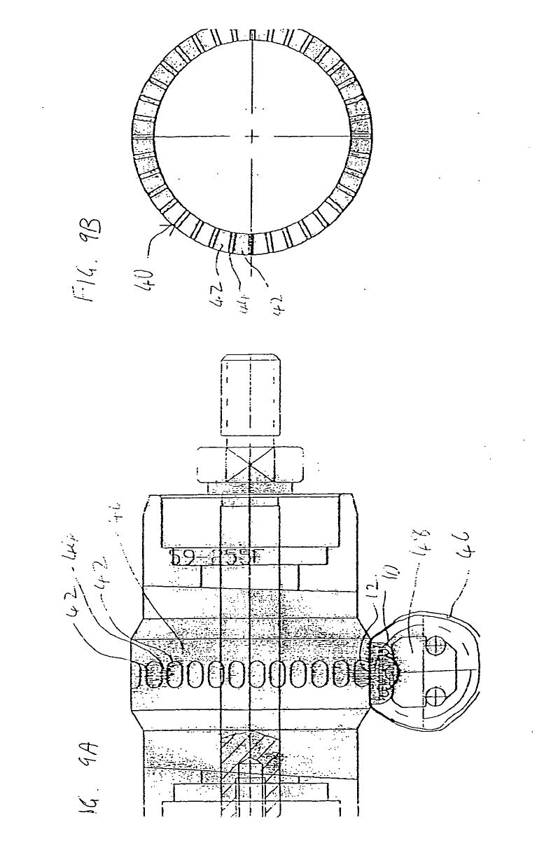

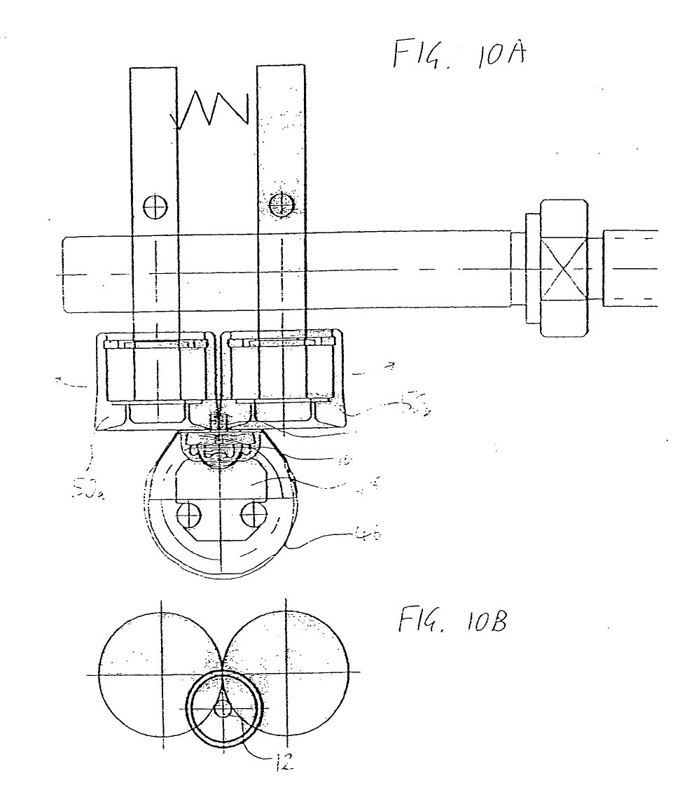

Turning first to FIGS. 9A and 9B, these show a first device including a roller 40 with multiple recesses 42 arrayed around its periphery. The walls 44 between recesses 42 are configured to guide projections into the apertures. To this end, they typically have either a rounded or chisel-edged form. Alternatively, the walls 44 between the apertures may be implemented as small freely-turning rollers (not shown). During operation, roller 40 turns in contact with the extruded tube 46. When an emitter, supported by a track 48, approaches the region of contact of roller 40, the bulge formed by the outlet-defining projection seats itself into one of recesses 42 and walls 44 press around it, thereby ensuring sufficient contact between the wall of tube 46 and lower surface 36 to achieve sealing connection.

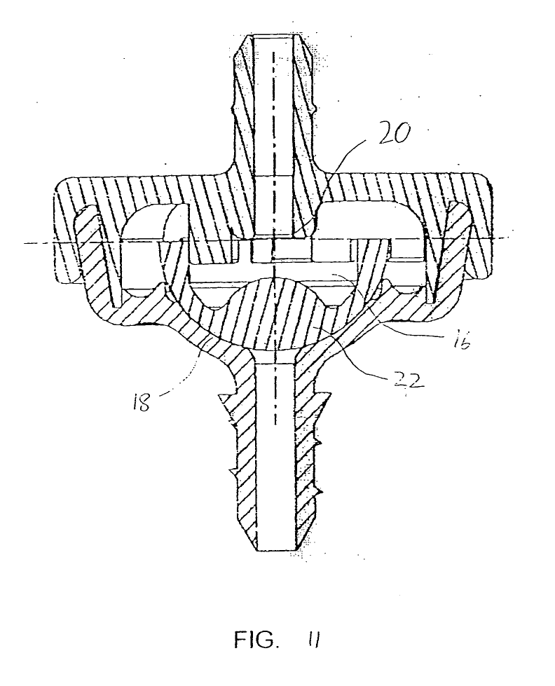

FIGS. 10A and 10B show an alternative device including a pair of displaceable wheels 50a and 50b. Specifically, wheels 50a and 50b are mounted so as to be rotatable on axles 52a and 52b which are biased by a spring 54 to press the wheels 50a and 50b together. At least the peripheral portions of the edge surfaces 56 of wheels 50a and 50b are deployed to slide in contact with the surface of tube 46 as it travels along the production line. When an emitter, supported by a track 48, approaches the region of contact of wheels 50a and 50b, the bulge formed by the outlet-defining projection pushes wheels 50a and 50b apart slightly against spring 54, returning immediately to their initial positions as the bulge passes. The pattern of overlapping contact between edge surfaces 56 and lower surface 36 is seen in FIG. 10B. The resulting contact profile is sufficient to ensure sealing contact at least around the periphery of surface 36. In fact, both in this case and the previous case, contact between the soft material of the extruded tube and lower surface 36 is typically effective to cause an effective sealing attachment over a much larger area than the area of direct application of pressure.

It should be appreciated that the devices of FIGS. 9A-10B are merely exemplary of a wide range of different production techniques which may be used to implement a drip irrigation tube including emitter elements of the typed described herein. Other possibilities include, but are not limited to, various arrangements of synchronized conveyors and the like with recesses positioned to correspond to the positions of the outlet-defining projections.

Although the features for reducing the height of the flow regulator are preferably used in combination with the shaped diaphragm configuration of the present invention, it should be noted that each of these aspects of the present invention may alternatively be used independently. In all respects other than the features described above, the structure and operation of flow regulator 10 will be understood by analogy to the description of FIGS. 6A-7B in the above-referenced U.S. Pat. No. 5,820,028.

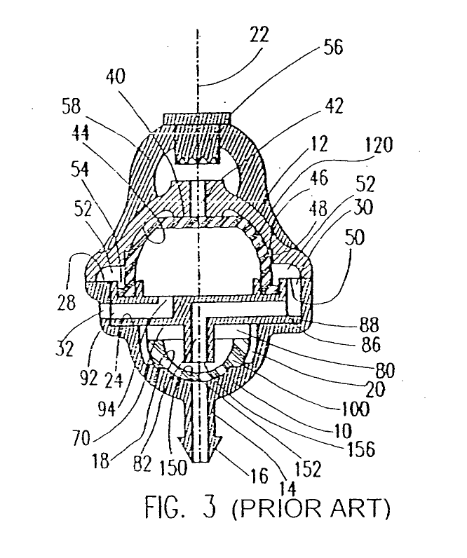

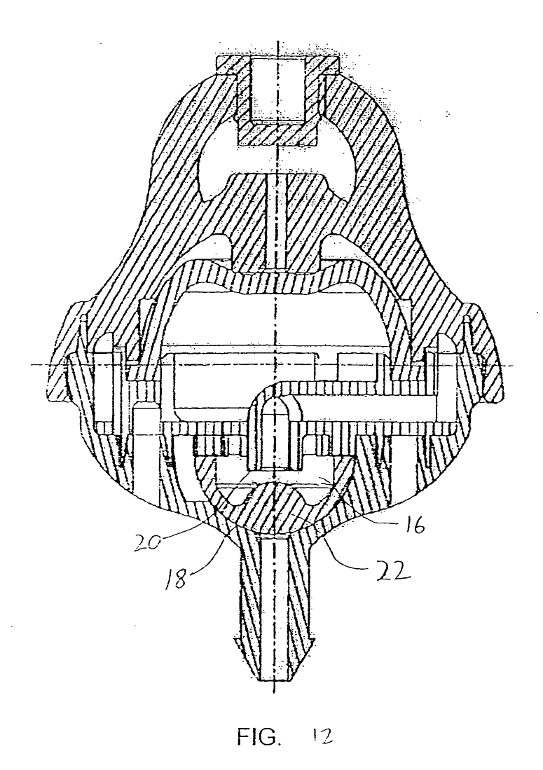

It should be noted that, while described herein principally with reference to one preferred example of a low-profile emitter for drip-irrigation tubes, the principles of the present invention are also applicable to substantially any pressure-responsive diaphragm-based flow regulator, particularly of types employing dome-shaped diaphragms. Thus, by way of example, FIGS. 11 and 12 show additional embodiments exemplifying the principles of the invention as applied to devices otherwise similar to those of FIGS. 2 and 3. In the case of FIG. 12, only the smaller inlet-side diaphragm is typically implemented according to the teachings of the present invention, although the larger outlet-side diaphragm could also be replaced if so required. In this context, it should be noted that, where the flow regulator structure of the present invention is used as a component of a larger device, the “outlet flow path” of the flow regulator structure may be internal with respect to the device as a whole, leading to the next component of the device. Here too, the details of the structure and operation of the examples shown will be understood by analogy to the description of the corresponding embodiments of the above-referenced U.S. Pat. No. 5,820,028.

It will be appreciated that the above descriptions are intended only to serve as examples, and that many other embodiments are possible within the spirit and the scope of the present invention.

1. A flow regulator for regulating a rate of flow of a liquid from an inlet flow path to an outlet flow path, the flows regulator comprising:
(i) a housing including at least one wall which defines, at least in part, a regulation chamber having a substantially annular surface and an outlet aperture in fluid communication with the outlet flow path; and
(ii) a flexible diaphragm deployed at least partially within said regulation chamber, said diaphragm having a first surface part of which faces towards said substantially annular surface and a second surface part of which faces towards said outlet aperture, said diaphragm assuming an initial unflexed position in which part of said first surface lies substantially adjacent to said substantially annular surface, said diaphragm being displaceable under pressure applied from the inlet flow path to a flexed position in which said first surface is at least partially removed from said substantially annular surface and a contact portion of said second surface substantially obstructs said outlet aperture,
wherein said diaphragm has at least one region having a minimum thickness defined as the distance between said first surface and said second surface, and a contact thickness defined as a distance from said contact portion to a part of said first surface, said contact thickness being at least about twice said minimum thickness.

2. The flow regulator of claim 1, wherein said contact thickness is at least about three times said minimum thickness.

3. The flow regulator of claim 1, wherein said diaphragm is substantially rotationally symmetric about an axis of symmetry passing through said contact portion, said contact thickness being measured parallel to said axis of symmetry.

4. The flow regulator of claim 1, wherein said first surface is substantially dome-shaped when said diaphragm assumes said unflexed state.

5. The flow regulator of claim 1, wherein said contact portion has a generally convexly curved shape in both said flexed and said unflexed positions of said diaphragm.

6. The flow regulator of claim 5, wherein said second surface approximates to part of a spherical surface over said contact portion.

7. The flow regulator of claim 6, wherein said outlet aperture has an internal diameter, said contact portion of said second surface approximating to part of a spherical surface having a radius of curvature not less than said internal diameter.

8. The flow regulator of claim 1, wherein said at least one region having a minimum thickness includes an annular region circumscribing said contact portion in a substantially symmetrical configuration.

9. The flow regulator of claim 1, wherein said first surface has a maximum height when said diaphragm assumes said unflexed state, said housing extending upwards around said diaphragm to no more than about two-thirds of said maximum height.

10. The flow regulator of claim 1, wherein said part of said first surface lies substantially in sealing abutment with said substantially annular surface when said diaphragm assumes said initial unflexed position.

11. The flow regulator of claim 1, wherein said part of said first surface and said substantially annular surface are configured to allow passage of water therebetween when said diaphragm assumes said initial unflexed position.

12. A drip irrigation system comprising:
(i) a drip irrigation tube having an internal surface; and
(ii) a plurality of flow regulators, each as defined in claim 1, deployed on said internal surface,
wherein each of said flow regulators further includes at least one outlet-defining projection extending substantially through said drip irrigation tube, said at least one outlet-defining projection being configured to define, at least in part, an outlet flow path in direct fluid communication with said outlet aperture and traversing said drip irrigation tube.

13. A flow regulator for regulating a rate of flow of a liquid from an inlet flow path to an outlet flow path, the flow regulator comprising:
(i) a housing including at least one wall which defines, at least in part a regulation chamber having a substantially annular surface and an outlet aperture in fluid communication with the outlet flow path; and
(ii) a flexible diaphragm deployed at least partially within said regulation chamber, said diaphragm having a first surface part of which faces towards said substantially annular surface and a second surface part of which faces towards said outlet aperture, said diaphragm assuming an initial unflexed position in which part of said first surface lies substantially adjacent to said substantially annular surface, said diaphragm being displaceable under pressure applied from the inlet flow path to a flexed position in which said first surface is at least partially removed from said substantially annular surface and a contact portion of said second surface substantially obstructs said outlet aperture,
wherein said first surface has a maximum height when said diaphragm assumes said unflexed state, said housing extending upwards around said diaphragm to no more than about two-thirds of said maximum height.

14. A drip irrigation system comprising:
(i) a drip irrigation tube formed by a tubular wall and having an internal surface; and
(ii) a plurality of drip emitters deployed on said internal surface, each of said drip emitters extending around less than the entire periphery of said internal surface, each of said drip emitters having at least one outlet-defining projection Which extends substantially through said tubular wall to define an outlet flow path.

15. The drip irrigation system of claim 14, wherein said at least one outlet-defining projection is implemented as an outlet pipe, said outlet flow path passing through said outlet pipe.

16. The drip irrigation system of claim 14, wherein each of said drip emitters includes:
(i) a housing including at least one wall which defines, at least in part, a regulation chamber having a substantially annular surface and an outlet aperture, said outlet aperture being in direct fluid communication with said outlet flow path; and
(ii) a flexible diaphragm deployed at least partially within said regulation chamber, said diaphragm having a first surface part of which faces towards said substantially annular surface and a second surface part of which faces towards said outlet aperture, said diaphragm assuming an initial unflexed position in Which part of said first surface lies substantially adjacent to said substantially annular surface, said diaphragm being displaceable under pressure supplied within said drip irrigation tube to a flexed position in which said first surface is at least partially removed from said substantially annular surface and a contact portion of said second surface substantially obstructs said outlet aperture.

17. The drip irrigation system of claim 3, wherein said first surface has a maximum height when said diaphragm assumes said unflexed state, said housing extending upwards around said diaphragm to no more than about two-thirds of said maximum height.
